(19) United States
(12) Patent Application Publication
(10) Pub. No.: US 2026/0135303 A1
(43) Pub. Date: May 14, 2026

(54) ELECTRONIC DEVICE

(71) Applicant: Advanced Semiconductor Engineering, Inc., Kaohsiung (TW)

(72) Inventor: Yi-Jhan SHIH, Kaohsiung (TW)

(73) Assignee: Advanced Semiconductor Engineering, Inc., Kaohsiung (TW)

(21) Appl. No.: 18/942,369

(22) Filed: Nov. 8, 2024

(51) Int. Cl. H01Q 19/19

(52) U.S. Cl. CPC H01Q 19/19

(57) ABSTRACT

The present disclosure provides an electronic device. The electronic device includes an antenna pattern, a directing structure, and a concentrating structure. The directing structure is coupled to the antenna pattern. The concentrating structure includes a dielectric resonant antenna (DRA) and a reflection component disposed over the DRA. The reflection component is configured to guide a first electromagnetic signal from the antenna pattern to the directing structure or guide a second electromagnetic signal from the directing structure to the antenna pattern.

### BACKGROUND

### 1. Technical Field

The present disclosure relates to an electronic device.

### 2. Description of the Related Art

To reduce the size of electronic devices and achieve higher integration density, several packaging solutions have been developed and implemented, such as antenna in package (AiP), antenna on package (AoP), or the like. For example, a horn antenna may be used to transmit an electromagnetic wave(s). In conventional devices, sidelobe signals can diminish the overall energy of electromagnetic waves, leading to decreased performance. Therefore, it is essential to develop new technologies or improve existing ones.

### SUMMARY

In some embodiments, an electronic device includes an antenna pattern, a directing structure, and a concentrating structure. The directing structure is coupled to the antenna pattern. The concentrating structure includes a dielectric resonant antenna (DRA) and a reflection component disposed over the DRA. The reflection component is configured to guide a first electromagnetic signal from the antenna pattern to the directing structure or guide a second electromagnetic signal from the directing structure to the antenna pattern.

In some embodiments, an electronic device includes an antenna pattern, a circuit structure, and a directing structure. The directing structure is coupled to the antenna pattern. The directing structure has a parabolic surface configured to transform a divergent wave to a plane wave between the directing structure and the antenna pattern. The circuit structure is separated the antenna from the directing structure.

In some embodiments, an electronic device includes an antenna pattern, a directing structure, and a concentrating structure. The concentrating structure is configured to transceive a first electromagnetic wave between the antenna and the directing structure. The directing structure surrounds the concentrating structure and is configured to reflect a second electromagnetic wave from or toward the concentrating structure.

### BRIEF DESCRIPTION OF THE DRAWINGS

Aspects of some arrangements of the present disclosure are best understood from the following detailed description when read with the accompanying figures. It is noted that various structures may not be drawn to scale, and dimensions of the various structures may be arbitrarily increased or reduced for clarity of discussion.

FIG. 1A illustrates a three-dimensional view of an electronic device in accordance with some arrangements of the present disclosure.

FIG. 1B illustrates a three-dimensional cross-sectional view of the electronic device as shown in FIG. 1A in accordance with some arrangements of the present disclosure.

FIG. 1C illustrates a cross-sectional view of the electronic device as shown in FIG. 1A in accordance with some arrangements of the present disclosure.

FIG. 1D illustrates the paths of electromagnetic waves of the electronic device as shown in FIG. 1A in accordance with some arrangements of the present disclosure.

FIG. 2 illustrates a cross-sectional view of an electronic device in accordance with some arrangements of the present disclosure.

FIGS. 3A, 3B, 3C, 3D, and 3E illustrate cross-sectionals views of concentrating structures in accordance with some arrangements of the present disclosure.

FIGS. 4A, 4B, 4C, 4D, 4E, and 4F illustrate various stages of a method for manufacturing an electronic device in accordance with some embodiments of the present disclosure.

### DETAILED DESCRIPTION

The following disclosure provides for many different arrangements, or examples, for implementing different features of the provided subject matter. Specific examples of components and arrangements are described as follows to explain certain aspects of the present disclosure. These are, of course, merely examples and are not intended to be limiting. For example, the formation of a first feature over or on a second feature in the description that follows may include arrangements in which the first and second features are formed or disposed in direct contact, and may also include arrangements in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various arrangements and/or configurations discussed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of arrangements of this disclosure are not deviated from by such arrangement.

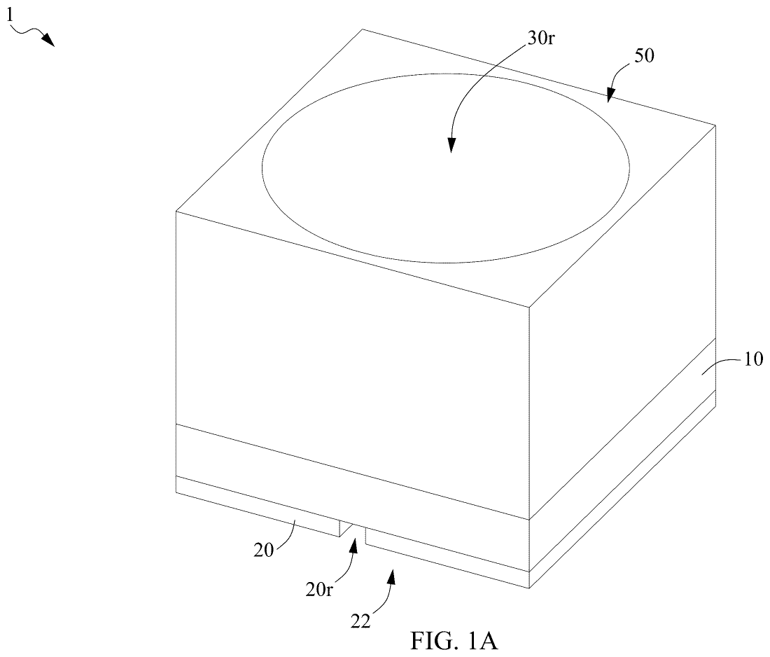

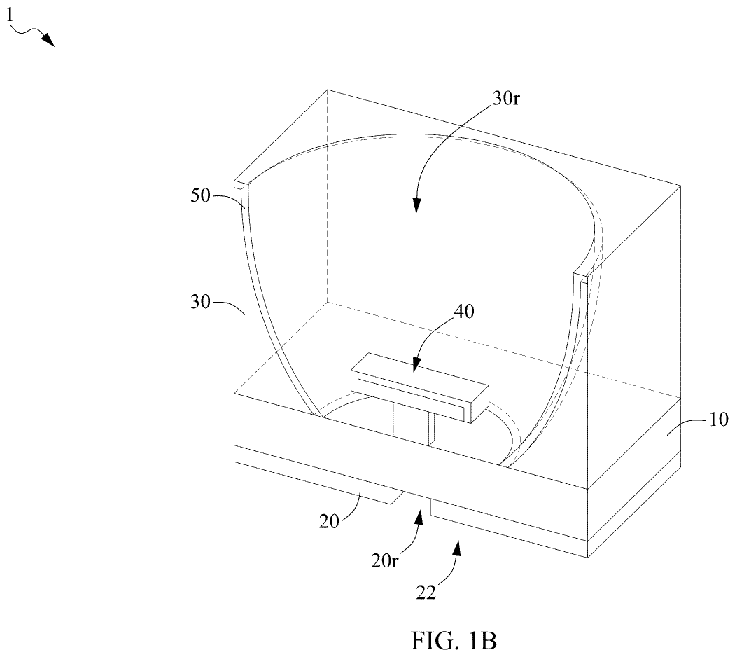

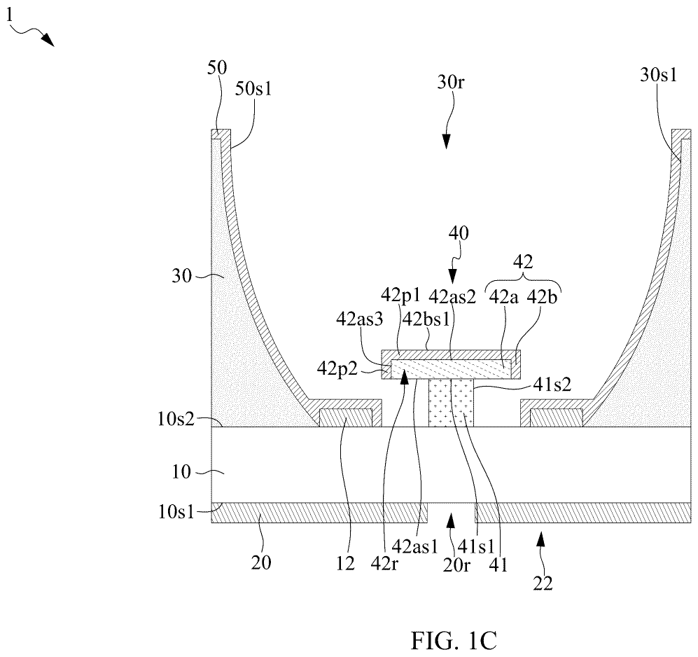

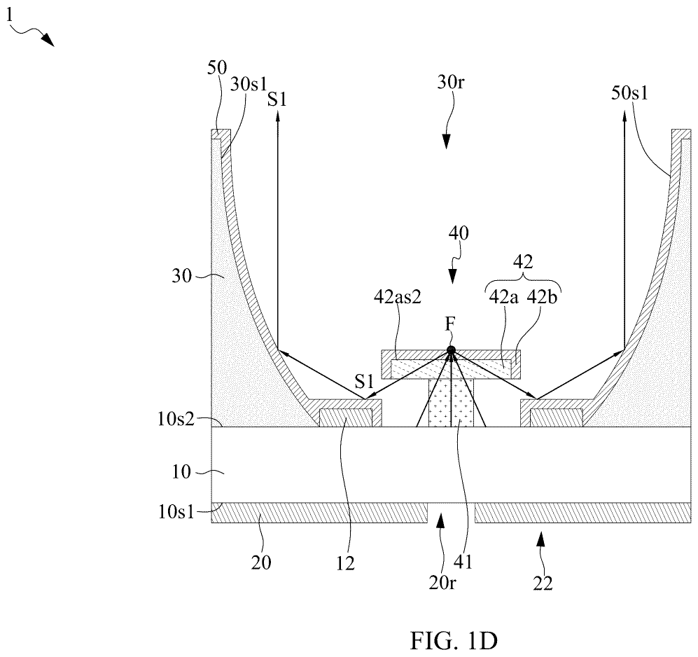

FIGS. 1A, 1B, 1C, and 1D illustrate an electronic device 1 in accordance with some arrangements of the present disclosure. In some embodiments, the electronic device 1 may be applicable to, for example, a wireless device, such as a user equipment (UE), a mobile station, a mobile device, an apparatus communicating with the Internet of Things (IoT), etc. In some embodiments, the electronic device 1 may be or include a portable device. In some embodiments, the electronic device 1 may support fifth generation (5G) communications, such as Sub-6 GHz frequency bands and/or millimeter (mm) wave frequency bands. For example, the electronic device 1 may incorporate both Sub-6 GHz devices and mm wave devices. In some embodiments, the electronic device 1 may support beyond—5G or 6G communications, such as terahertz (THz) frequency. The electronic device 1 may be configured to radiate and/or receive electromagnetic signals, such as radio frequency (RF) signals. For example, the electronic device 1 may be configured to operate in a frequency between about 10 GHz and about 10 THz, such as 10 GHz, 20 GHz, 30 GHz, 40 GHz, 50 GHz, 100 GHz, 300 GHz, 1 THz, 5 THz, or 10 THz.

As shown in FIGS. 1A and 1B, in some embodiments, the electronic device 1 may include a carrier 10, conductive elements 20, a directing structure supporter 30, a concentrating structure 40, and a directing structure 50. The directing structure supporter 30 may be disposed on or over the carrier 10. In some embodiments, the directing structure supporter 30 may define a recess 30r (or cavity or opening). In some embodiments, the concentrating structure 40 may be exposed by the recess 30r. In some embodiments, the directing structure 50 may be supported by the directing structure supporter 30. In some embodiments, the directing structure 50 may be conformally disposed on or over the directing structure supporter 30. A portion of the directing structure 50 may be disposed within the recess 30r. In some embodiments, the directing structure 50 may inherit the profile of the directing structure supporter 30 and define a recess, which inherits the profile of the recess 30r, exposing the concentrating structure 40. In some embodiments, the concentrating structure 40 and the directing structure 50 may be configured to define a substantial horn antenna.

Referring to FIG. 1C, the carrier 10 may include a printed circuit board (PCB), such as a paper-based copper foil laminate, a composite copper foil laminate, or a polymer-impregnated glass-fiber-based copper foil laminate. The carrier 10 may include a flexible printed circuit board (FPCB). In some embodiments, the carrier 10 may include an interconnection structure, such as a redistribution layer (RDL) or a grounding element, embedded within dielectric layers. The dielectric layers of the carrier 10 may include polypropylene, polyimide, or other suitable materials. In some embodiments, the carrier 10 may be a redistribution structure, which includes conductive traces and vias embedded within dielectric layers.

The carrier 10 may include a surface 10s1 (or a lower surface) and a surface 10s2 (or an upper surface) opposite to the surface 10s1. In some embodiments, the electronic device 1 may include pads 12. In some embodiments, the pads 12 may be disposed on or over the surface 10s2 of the carrier 10. In some embodiments, the pads 12 may be electrically coupled to the ground. Although FIGS. 1C and 1D illustrate that the pads 12 protrude from the surface 10s2 of the carrier 10, the pads 12 may be embedded within the carrier 10 in other embodiments.

The conductive elements 20 may be disposed on or under the surface 10s1 of the carrier 10. In some embodiments, the conductive elements 20 may define one or more slots 20r, which expose the surface 10s1 of the carrier 10. In some embodiments, the conductive elements 20 may be electrically connected to ground. In some embodiments, the conductive elements 20 and/or the slots 20r may function as a part of an antenna 22. In some embodiments, the antenna 22 may be configured to radiate and/or receive electromagnetic signals, such as radio frequency (RF) signals. For example, the antenna 22 may be configured to operate in a frequency between about 10 GHz and about 10 THz, such as 10 GHz, 20 GHz, 30 GHz, 40 GHz, 50 GHz, 100 GHz, 300 GHz, 1 THz, 5 THz, or 10 THz. In some embodiments, the antenna 22 may support fifth generation (5G) communications, such as Sub-THz frequency bands and/or millimeter (mm) wave frequency bands. In some embodiments, the antenna 22 may include a slot antenna, patch antenna, or other suitable antennas. In some embodiments, the antenna 22 may further include other elements, such as radiator(s), feeding element(s), or other suitable elements. In some embodiments, when the wavelength of an electromagnetic wave from a radiator is within the specific wavelength, said electromagnetic wave may pass through the slots 20r.

In some embodiments, the directing structure supporter 30 (or directing structure holder) may be disposed on or over the surface 10s2 of the carrier 10. In some embodiments, the directing structure supporter 30 may be configured to support the directing structure 50. In some embodiments, a portion of the surface 10s2 of the carrier 10 may be exposed by the directing structure supporter 30. In some embodiments, the directing structure supporter 30 may be a monolithic structure. For example, the material of the directing structure supporter 30 is stacked, deposited, coated by one step or one cycle and does not have two or more stacked layers. In some embodiments, the directing structure supporter 30 may include an opaque material. In some embodiments, the directing structure supporter 30 may include a light transmissive material. In some embodiments, the directing structure supporter 30 may include an electrically insulative material. The directing structure supporter 30 may include a novolac-based resin, an epoxy-based resin, a silicone-based resin, or another suitable material. In some embodiments, the directing structure supporter 30 may include, for example, rubber, silicon, polyester, polyurethane, or other suitable materials such as an elastic material, a soft material, a sponge-like material, or a flexible material. In some embodiments, the directing structure supporter 30 may include an encapsulant or a molding compound.

In some embodiments, the directing structure supporter 30 may define a recess 30r exposing the concentrating structure 40. The recess 30r may have a larger aperture far from the carrier 10 and a smaller aperture abutting the carrier 10. In some embodiments, the directing structure supporter 30 may include a surface 30s1 (or a lateral surface) defining the recess 30r. In some embodiments, the surface 30s1 may include a curved surface. In some embodiments, the surface 30s1 may include a curved surface. In some embodiments, the surface 30s1 may include a parabolic-shaped profile. In some embodiments, the profile of the surface 30s1 may substantially satisfy the function of a parabola, and thus have at least one focal point. In some embodiments, the surface 30s1 may be a substantially continuous surface. In some embodiments, the dielectric constant of the directing structure supporter 30 may range between 1 and 20, such as 1, 3, 5, 7, 10, 12, 14, 16, 18, or 20.

In some embodiments, the concentrating structure 40 may be disposed on or over the surface 10s2 of the carrier 10. In some embodiments, the concentrating structure 40 may protrude from the surface 10s2 of the carrier 10. In some embodiments, the concentrating structure 40 may be configured to concentrate signals (e.g., electromagnetic waves). For example, the concentrating structure 40 may be configured to prevent signals (e.g., electromagnetic waves) from passing through the upper surface of the concentrating structure 40. In some embodiments, the concentrating structure 40 may be configured to allow more signals to be guided to the directing structure 50. In some embodiments, the concentrating structure 40 may include a dielectric layer 41 and a reflection component 42.

The dielectric layer 41 may be disposed on or over the surface 10s2 of the carrier 10. In some embodiments, the dielectric layer 41 may include a dielectric resonant antenna (DRA). In some embodiments, the dielectric layer 41 may abut the carrier 10. The dielectric layer 41 may be disposed between the reflection component 42 and the carrier 10. The dielectric layer 41 may include a dielectric material. In some embodiments, the dielectric constant of the dielectric layer 41 may range between 10 and 20, such as 10, 12, 14, 16, 18, or 20, which may improve the gain of signals.

In some embodiments, the reflection component 42 may be disposed on or over the dielectric layer 41. The reflection component 42 may overhang the dielectric layer 41. For example, the edge of the reflection component 42 may exceed the edge of the dielectric layer 41. In some embodiments, the reflection component 42 may be configured to reflect or guide signals to the directing structure 50. For example, the reflection component 42 may be configured to guide an electromagnetic signal from the antenna 22 to the directing structure 50 or guide an electromagnetic signal from the directing structure 50 to the antenna 22.

In some embodiments, the width (e.g., the dimension along a horizontal direction) of the reflection component 42 may be greater than that of the dielectric layer 41. In some embodiments, the reflection component 42 may include a dielectric layer 42a and a reflection layer 42b.

In some embodiments, the dielectric layer 42a may be disposed on or over the dielectric layer 41. The dielectric layer 42a may overhang the dielectric layer 41. For example, the edge of the dielectric layer 42a may exceed the edge of the dielectric layer 41. In some embodiments, the dielectric layer 42a may be disposed between the reflection layer 42b and the dielectric layer 41. In some embodiments, the width (e.g., the dimension along a horizontal direction) of the dielectric layer 42a may be greater than that of the dielectric layer 41. In some embodiments, the dielectric layer 42a may include a dielectric material. In some embodiments, the dielectric constant of the dielectric layer 42a may range between 10 and 20, such as 10, 12, 14, 16, 18, or 20, which may improve the gain of signals. In some embodiments, the dielectric constant of the dielectric layer 42a may be substantially the same as that of the dielectric layer 41. In some embodiments, the material of the dielectric layer 42a may be the same as that of the dielectric layer 41. In some embodiments, the material of the dielectric layer 42a may be different from that of the dielectric layer 41, and the difference of the dielectric constant between the dielectric layer 41 and the dielectric layer 42a may be less than 10, such as 10, 8, 6, 4, 2, or 0. In some embodiments, the dielectric layers 41 and 42a may collectively function as the DRA.

In some embodiments, the reflection layer 42b may be disposed on or over the dielectric layer 42a. In some embodiments, the reflection layer 42b may cover the dielectric layer 42a. In some embodiments, the reflection layer 42b may define a cavity 42r (or recess) accommodating the dielectric layer 42a. The reflection layer 42b may reflect signals, such as electromagnetic waves. In some embodiments, the reflection layer 42b may be configured to concentrate signals. For example, the reflection layer 42b may be configured to prevent signals from passing through the upper surface (e.g., surface 42bs1) of the concentrating structure 40. In some embodiments, the reflection layer 42b may be configured to allow more signals to be guided to the directing structure 50. In some embodiments, the reflection layer 42b may include metal or metal alloy, such as copper, aluminum, nickel, gold, tungsten, silver, a combination thereof, or other suitable materials.

The dielectric layer 41 may have a surface 41s1 (or an upper surface) and a surface 41s2 (or a lateral surface) extending between the surface 41s1 and the surface 10s2 of the carrier 10. The dielectric layer 42a may have a surface 42as1 (or a lower surface), a surface 42as2 (or an upper surface), and a surface 42as3 (or a lateral surface) extending between the surface 42as1 and surface 42as2. The reflection layer 42b may have a surface 42bs1 (or an upper surface). In some embodiments, the surface 41s1 of the dielectric layer 41 may be substantially aligned with the surface 42as1 of the dielectric layer 42a. The reflection layer 42b may have a portion 42p1 over the dielectric layer 41as2 and a portion 42p2 covering the surface 42as3. The portion 42p1 and portion 42p2 may collectively define the cavity 42r accommodating the dielectric layer 42a. In some embodiments, the surface 42as1 may be exposed to air. In some embodiments, the surface 42as1 may be exposed to the recess 30r. In some embodiments, the surface 41s2 may be exposed to air. In some embodiments, the surface 41s2 may be exposed to the recess 30r.

In some embodiments, the directing structure 50 may be disposed on or over the directing structure supporter 30. In some embodiments, the directing structure 50 may be conformally disposed on the directing structure supporter 30. In some embodiments, the directing structure 50 may be electrically connected to the pads 12. In some embodiments, the directing structure 50 may cover the upper surface and lateral surface of the pads 12. In some embodiments, the directing structure 50 may be in contact with the surface 10s2 of the carrier 10. In some embodiments, the directing structure 50 may include a surface 50s1 (or a lateral surface) defining a recess, which has a profile that inherits the profile of the surface 30s1. In some embodiments, the surface 50s1 may include a curved surface. In some embodiments, the surface 50s1 may include a parabolic-shaped profile. In some embodiments, the profile of the surface 50s1 may substantially satisfy the function of a parabola, and have at least one focal point. In some embodiments, the surface 50s1 may be a substantially continuous surface. In some embodiments, the top of the directing structure 50 may be at an elevation, with respect to the carrier 10, greater than that of the top of the concentrating structure 40.

Referring to FIG. 1D, when electromagnetic waves S1 are transmitted to the reflection layer 42b, the electromagnetic waves S1 may pass through the dielectric layer 41 and dielectric layer 42a. Next, the electromagnetic waves S1 may be reflected by the reflection layer 42b. In some embodiments, the electromagnetic waves S1 may be reflected to the directing structure 50. Next, the electromagnetic waves S1 may be directed to the surroundings along a direction which is substantially parallel to the normal direction of the surface 10s2 of the carrier 10. In this condition, the reflection layer 42b may be disposed at a location substantially the same as or abutting the focal point F of the surface 30s1 of the directing structure supporter 30 (or the focal point of the surface 50s1 of the directing structure 50). For example, the surface 41s1 of the dielectric layer 41 may be located at an elevation substantially the same as that of the focal point F of the surface 30s1 of the directing structure supporter 30 (or the surface 50s1 of the directing structure 50). In some embodiments, the concentrating structure 40 and the directing structure 50 may be configured to transmit a divergent sphere wave to a plane wave. For example, when the electromagnetic waves S1 are emitted from the antenna 22 toward the concentrating structure 40, the electromagnetic waves S1 may be divergent sphere waves. After the electromagnetic waves S1 are reflected by the concentrating structure 40 and the directing structure 50, the electromagnetic waves S1 are transformed into plane waves. Similarly, when a divergent sphere wave is transmitted to the electronic device 1 from an external environment, the divergent sphere wave may be reflected by the directing structure 50 and the concentrating structure 40 in order, and then transformed into a plane wave.

In a comparative example, a horn antenna allows signals to pass through the upper surface of the DRA, resulting in some signals becoming divergent waves with greater sidelobe signals, reducing the device's performance. In this embodiment, the reflection layer 42b and the directing structure 50 can be configured to convert divergent waves into plane waves, increasing the power of the main lobe(s) and improving the performance of electronic device 1.

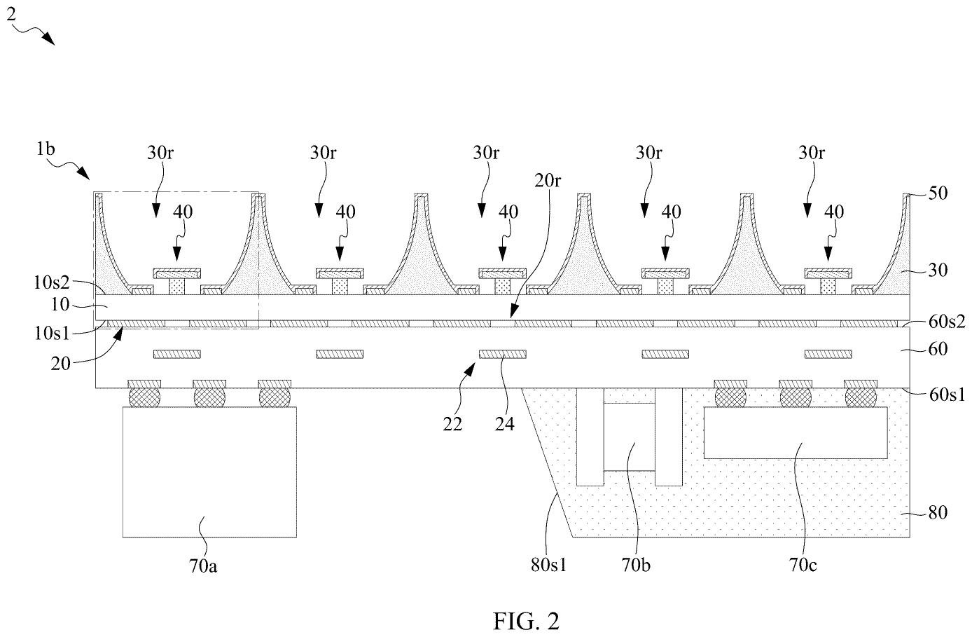

FIG. 2 illustrates a cross-sectional view of an electronic device 2 in accordance with some arrangements of the present disclosure.

In some embodiments, the electronic device 2 may include a circuit structure 60. The circuit structure 60 may be configured to support a plurality of devices 1b. In some embodiments, the device 1b may include a structure the same as or similar to that of the electronic device 1. For example, the electronic device 2 may include two or more concentrating structures 40, each of which is disposed within the corresponding recess 30r. In some embodiments, the concentrating structures 40 may be spaced apart from each other by the directing structure supporter 30. In some embodiments, the concentrating structures 40 may be spaced apart from each other by the directing structure 50. The antenna 22 may include a radiator 24. The radiator 24 may be located within the circuit structure 60. The radiator 24 may be configured to emit an electromagnetic wave.

In some embodiments, the circuit structure 60 may be disposed on or under the surface 10s1 of the carrier 10. In some embodiments, the circuit structure 60 may include a PCB, such as a paper-based copper foil laminate, a composite copper foil laminate, or a polymer-impregnated glass-fiber-based copper foil laminate. The circuit structure 60 may include a FPCB. In some embodiments, the circuit structure 60 may include an interconnection structure, such as an RDL or a grounding element, embedded within dielectric layers. The dielectric layers of the circuit structure 60 may include polypropylene, polyimide, or other suitable materials.

The circuit structure 60 may include a surface 60s1 (or a lower surface) and a surface 60s2 (or an upper surface) opposite to the surface 60s1. The circuit structure 60 may include one or more conductive pads in proximity to, adjacent to, or embedded in and exposed from the surface 60s1 and/or surface 60s2 of the circuit structure 60.

In some embodiments, the electronic device 2 may include electronic components 70a, 70b, and 70c. The electronic components 70a, 70b, and 70c may be disposed on or under the surface 60s1 of the circuit structure 60. The electronic components 70a, 70b, and 70c may be electrically connected to one or more other electrical components (if any) and to the circuit structure 60 (e.g., to the interconnection(s)), and the electrical connection may be attained by way of flip-chip, wire-bond techniques, metal to metal bonding (such as Cu to Cu bonding), or hybrid bonding. The electronic components 70a, 70b, and 70c may be a chip or a die including a semiconductor substrate, one or more integrated circuit (IC) devices and one or more overlying interconnection structures therein. The IC devices may include active devices such as transistors and/or passive devices such as resistors, capacitors, inductors, or a combination thereof. For example, the electronic components 70a, 70b, and 70c may include a system on chip (SoC). For example, the electronic components 70a, 70b, and 70c may include a radio frequency integrated circuit (RFIC), an application-specific IC (ASIC), a central processing unit (CPU), a microprocessor unit (MPU), a graphics processing unit (GPU), a microcontroller unit (MCU), a field-programmable gate array (FPGA), or another type of IC. In some embodiments, the electronic components 70a, 70b, and 70c may be configured to provide the antenna 22 with a signal (e.g., a feed signal) through the circuit structure 60. In some embodiments, the electronic components 70a and 70c may be active devices, and the electronic component 70b may be a passive device. In some embodiments, the electronic component 70a may be a connector, which is configured to provide an electrical path between the electronic device 2 and an external device. The connector may include, for example, a board to board connector.

In some embodiments, the electronic device 2 may include an encapsulant 80. In some embodiments, the encapsulant 80 may be disposed on or over the surface 60s1 of the circuit structure 60. The encapsulant 80 may encapsulate the electronic components 70b and 70c. In some embodiments, a portion of the surface 60s1 may be exposed by the encapsulant 80. The encapsulant 80 may have a surface 80s1 (or a lateral surface). In some embodiments, the surface 80s1 of the encapsulant 80 may be slanted with respect to the surface 60s1 of the circuit structure 60. In some embodiments, the encapsulant 80 may include insulation or dielectric material. In some embodiment, the encapsulant 80 may be made of molding material that may include, for example, a novolac-based resin, an epoxy-based resin, a silicone-based resin, or another suitable encapsulant. Suitable fillers may also be included, such as powdered SiO₂. In some embodiments, the encapsulant 80 may be applied using any of a number of molding techniques, such as compression molding, injection molding, or transfer molding.

In some embodiments, the horn antenna array shown in FIG. 2 may function as an antenna array. Signal phase may be modified by beam steering. As a result, the radiation direction of electromagnetic wave(s) may be controlled, meeting the requirement for precise directionality.

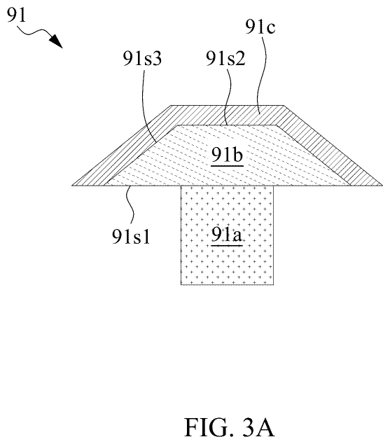

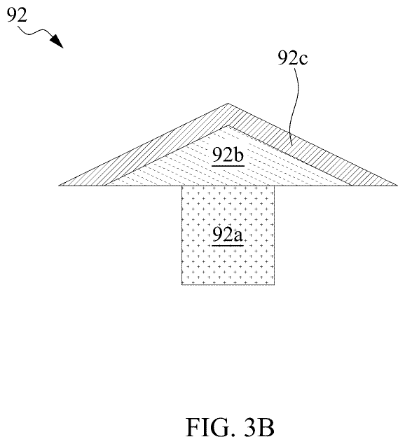

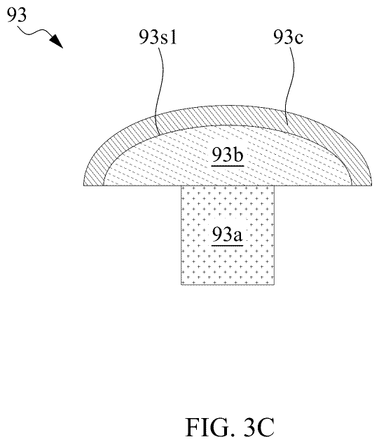

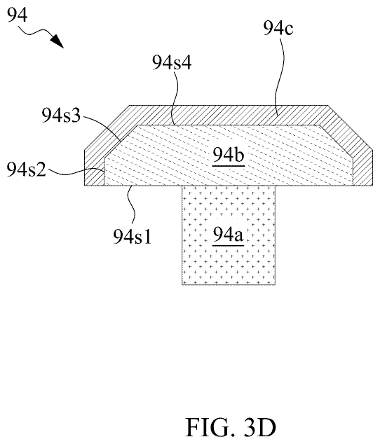

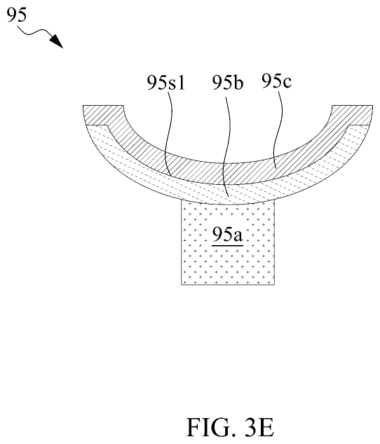

FIGS. 3A, 3B, 3C, 3D, and 3E illustrate cross-sectionals views of concentrating structures 91, 92, 93, 94, and 95 in accordance with some arrangements of the present disclosure. The concentrating structures 91, 92, 93, 94, and 95 may be applied to the electronic devices 1 and 2.

Referring to FIG. 3A, the concentrating structure 91 may include a DRA 91a, a dielectric layer 91b, and a reflecting layer 91c. The dielectric layer 91b may be disposed over the DRA 91a. In some embodiments, the dielectric layer 91b may have a trapezoid-shaped profile. For example, the dielectric layer 91b may have a surface 91s1, a surface 91s2, and a surface 91s3, and the dimension (e.g., width or surface area) of the surface 91s2 may be less than that of the surface 91s1. The surface 91s3 may extend between the surface 91s1 and surface 91s2. In some embodiments, the surface 91s3 may be slanted with respect to the surface 91s1. In some embodiments, the reflecting layer 91c may be conformally disposed on or over the dielectric layer 91b and have a profile the same as or similar to that of the dielectric layer 91b.

Referring to FIG. 3B, the concentrating structure 92 may include a DRA 92a, a dielectric layer 92b, and a reflecting layer 92c. The dielectric layer 92b may be disposed over the DRA 92a. In some embodiments, the dielectric layer 92b may have a triangular-shaped profile. For example, the dielectric layer 92b may be an equilateral triangle or isosceles triangle. In some embodiments, the reflecting layer 92c may be conformally disposed on or over the dielectric layer 92b and have a profile the same as or similar to that of the dielectric layer 91b.

Referring to FIG. 3C, the concentrating structure 93 may include a DRA 93a, a dielectric layer 93b, and a reflecting layer 93c. The dielectric layer 93b may be disposed over the DRA 93a. In some embodiments, the dielectric layer 93b may have a semi-sphere profile or semi-oval profile. For example, the concentrating structure 93 may have a surface 93s1, and the surface 93s1 may be a curved surface. In some embodiments, the reflecting layer 93c may be conformally disposed on or over the dielectric layer 93b and have a profile the same as or similar to that of the dielectric layer 93b.

Referring to FIG. 3D, the concentrating structure 94 may include a DRA 94a, a dielectric layer 94b, and a reflecting layer 94c. The dielectric layer 94b may be disposed over the DRA 94a. The dielectric layer 94b may have a surface 94s1 (or a lower surface), a surface 94s2 connected to the surface 94s1, a surface 94s3 connected to the surface 94s2, and a surface 94s4 (or an upper surface) connected to the surface 94s3. In some embodiments, the surface 94s3 may be slanted with respect to the surface 94s4. In some embodiments, the surface 94s3 may be slanted with respect to the surface 94s2. In some embodiments, the surface 94s2 may be substantially orthogonal to the surface 94s1. In some embodiments, the reflecting layer 94c may be conformally disposed on or over the dielectric layer 94b and have a profile the same as or similar to that of the dielectric layer 94b.

Referring to FIG. 3E, the concentrating structure 95 may include a DRA 95a, a dielectric layer 95b, and a reflecting layer 95c. The dielectric layer 95b may be disposed over the DRA 95a. In some embodiments, the dielectric layer 95b may have a surface 95s1 which is concaved. In some embodiments, the reflecting layer 95c may be conformally disposed on or over the dielectric layer 95b and have a profile the same as or similar to that of the dielectric layer 95b.

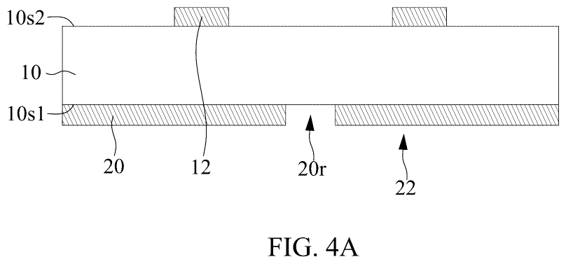

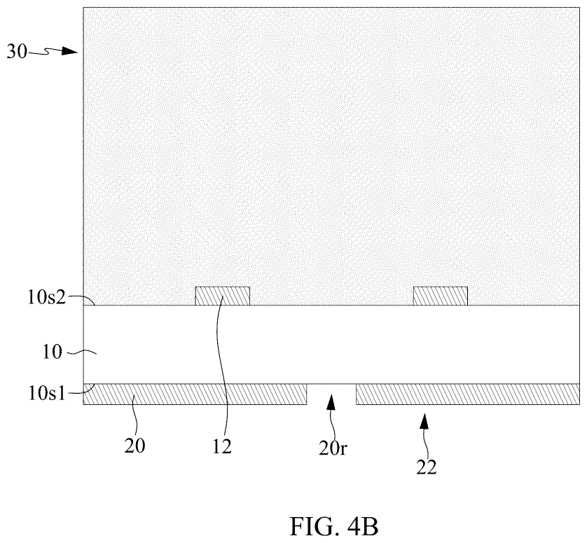

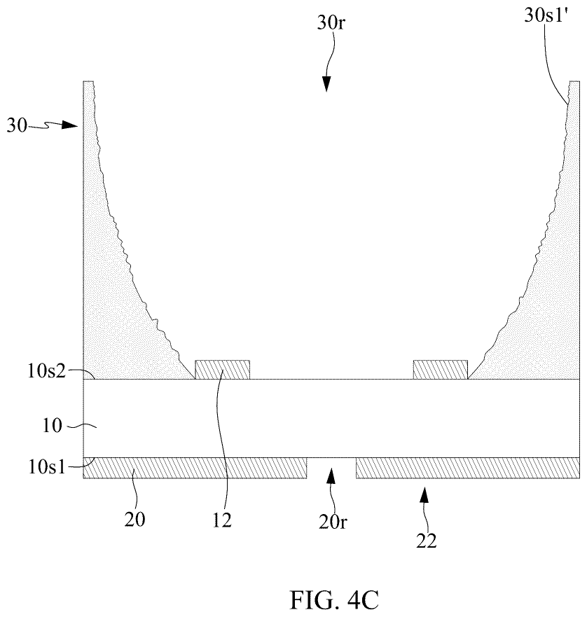

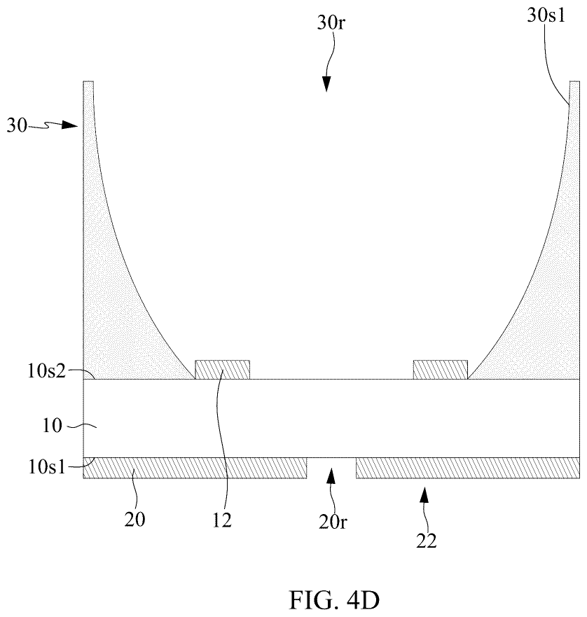

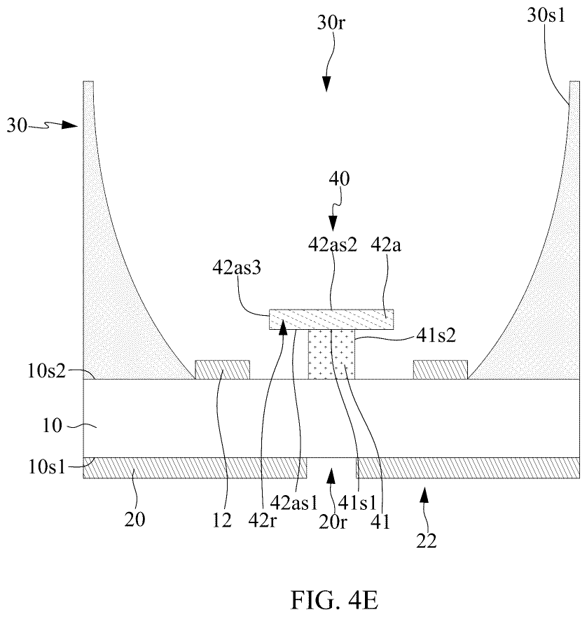

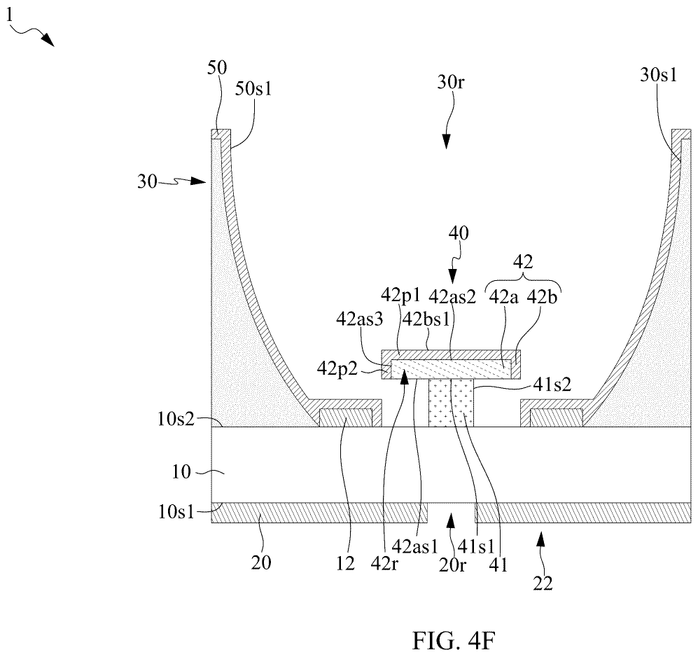

FIGS. 4A, 4B, 4C, 4D, 4E, and 4F illustrate various stages of a method for manufacturing an electronic device in accordance with some embodiments of the present disclosure.

Referring to FIG. 4A, the carrier 10 may be provided. The conductive elements 20 may be attached to the surface 10s1 of the carrier 10. The antenna 22 may be under the surface 10s1 of the carrier 10.

Referring to FIG. 4B, the directing structure supporter 30 may be formed on or over the surface 10s2 of the carrier 10. The directing structure supporter 30 may be formed by a molding technique, a coating technique, or other suitable techniques.

Referring to FIG. 4C, a portion of the directing structure supporter 30 may be removed. The pads 12 and a portion of the surface 10s2 of the carrier 10 may be exposed by the directing structure supporter 30. In some embodiments, the directing structure supporter 30 may be removed by a laser ablation technique or other suitable techniques. In this stage, the surface 30s1′ of the directing structure supporter 30 may have significant roughness.

Referring to FIG. 4D, the surface 30s1′ of the directing structure supporter 30 may be polished so that the surface 30s1 may be relatively smooth. As a result, the surface 30s1 of the directing structure supporter 30 may have a substantially parabolic-shaped profile. In some embodiments, the surface 30s1′ of the directing structure supporter 30 may be polished by a laser polishing technique or other suitable techniques.

Referring to FIG. 4E, the dielectric layer 41 and the dielectric layer 42a may be attached to the surface 10s2 of the carrier 10.

Referring to FIG. 4F, the reflection layer 42b may be formed on or over the dielectric layer 42a, and the directing structure 50 may be formed on the surface 30s1 of the directing structure supporter 30. As a result, the electronic device 1 may be produced. In some embodiments, the reflection layer 42b and the directing structure 50 may be formed by a sputter technique or other suitable techniques. In some embodiments, the thickness of the portion 42p1 may be greater than that of the portion 42p2 because of the conductive materials are deposited along a direction from directing structure supporter 30 to the carrier 10 during sputter technique.

As used herein, the singular terms “a,” “an,” and “the” may include a plurality of referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel can refer to a range of angular variation relative to 0°that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. For example, “substantially” perpendicular can refer to a range of angular variation relative to 90°that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
an antenna;
a directing structure coupled to the antenna; and
a concentrating structure, comprising a dielectric resonant antenna (DRA) and a reflection component disposed over the DRA,
wherein the reflection component is configured to guide a first electromagnetic signal from the antenna to the directing structure or guide a second electromagnetic signal from the directing structure to the antenna.

2. The electronic device of claim 1, wherein a width of the reflection component is greater than a width of the DRA.

3. The electronic device of claim 2, wherein the reflection component overhangs two opposite sides of the DRA.

4. The electronic device of claim 1, wherein the reflection component comprises a dielectric layer and a reflection layer over the dielectric layer, and the dielectric layer is configured to let the first electromagnetic signal and/or the second electromagnetic signal pass through, and the reflection layer is configured to reflect the first electromagnetic signal to the directing structure and/or reflect the second electromagnetic signal to the antenna.

5. The electronic device of claim 4, wherein a dielectric constant of the DRA is substantially the same as a dielectric constant of the dielectric layer of the reflection component.

6. The electronic device of claim 4, wherein the reflection layer defines a cavity to accommodate the dielectric layer.

7. The electronic device of claim 6, wherein the reflection layer has a curved surface.

8. The electronic device of claim 1, further comprising:
a carrier, wherein the directing structure and the concentrating structure are disposed over the carrier.

9. The electronic device of claim 8, further comprising:
an electronic component disposed under the carrier and configured to transmit a feed signal to the antenna.

10. The electronic device of claim 1, further comprising:
a directing structure supporter covered by the directing structure.

11. The electronic device of claim 10, wherein the directing structure supporter comprises a surface which has a substantially parabolic-shaped profile.

12. The electronic device of claim 10, wherein the directing structure defines a first recess to accommodate the concentrating structure.

13. The electronic device of claim 12, wherein the directing structure defines a second recess to accommodate an additional concentrating structure.

14. The electronic device of claim 13, wherein the concentrating structure is spaced apart from the additional concentrating structure by the directing structure supporter.

15. An electronic device, comprising:
an antenna;
a directing structure coupled to the antenna; and
a circuit structure separated the antenna from the directing structure,
wherein the directing structure has a substantially parabolic surface configured to transform a divergent wave to a plane wave.

16. The electronic device of claim 15, further comprising:
a concentrating structure supported by the circuit structure and configured to transfer an electromagnetic wave between the directing structure and the antenna.

17. The electronic device of claim 16, further comprising a directing structure supporter, wherein the directing structure is conformally disposed on the directing structure supporter.

18. An electronic device, comprising:
an antenna;
a directing structure; and
a concentrating structure configured to transceive a first electromagnetic wave between the antenna and the directing structure, wherein the directing structure surrounding the concentrating structure and configured to reflect a second electromagnetic wave from or toward the concentrating structure.

19. The electronic device of claim 18, further comprising:
a carrier supporting the directing structure, wherein the concentrating structure is protruded from the carrier, and a portion of the carrier is exposed by the directing structure.

20. The electronic device of claim 19, wherein the concentrating structure comprises a reflection layer defining a cavity recessed toward a direction away from the antenna.
